(19) United States
(12) Patent Application Publication
(10) Pub. No.: US 2012/0150863 A1
(43) Pub. Date: Jun. 14, 2012

(54) BOOKMARKING OF MEETING CONTEXT

(75) Inventors: Nathan James Fish, Seattle, WA (US); Joe Friend, Bothell, WA (US); Jeffrey Berg, Seattle, WA (US); Joo Young Lee, Redmond, WA (US); David B. Lee, Sammamish, WA (US); Nina Shih, Redmond, WA (US); Nicole Danielle Steinbok, Redmond, WA (US); Peter Rodes, Redmond, WA (US); Leslie Rae Ferguson, Seattle, WA (US); Laura Neumann, Kirkland, WA (US); Jeremy M. Santy, San Luis Obispo, CA (US)

(73) Assignee: MICROSOFT CORPORATION, Redmond, WA (US)

(21) Appl. No.: 12/965,965

(22) Filed: Dec. 13, 2010

(51) Int. Cl. G06F 17/30

(52) U.S. Cl. 707/741; 707/803; 707/758; 707/E17.014; 707/E17.049

(57) ABSTRACT

Architecture that facilitates the ability to trigger the capture and storing of meeting state (or context) by way of a single user interaction (a “one-click” operation), referred to herein as a bookmark operation, and then to store and access the state for subsequent use. The state is captured relative to a point of reference, such as time, user, keywords, and reference to a document, for example. Thus, all state elements such as meeting activities, participants, and content (e.g., audio, video, images, text, documents, etc.). The bookmark assigned to the state at a particular reference can be selected to rehydrate all the state elements captured and associated with that bookmark (e.g., getting back to the point in the meeting to perceive a relevant portion of a document, part of the meeting video, or other recorded feed), as well as all other allowed state elements.

### BACKGROUND

Retrieving content or events of interest which occurred during a meeting is a difficult, manual, and personal process based on human memory recall. For example, when a participant makes a note about the meeting, the note is not associated with a meeting context or available to others, attendees, or otherwise. Software used during meetings does not assist users with this task although the users are part of a meeting state.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the ability to trigger the capture and storing of meeting state (or context) by way of a single user interaction (a “one-click” operation), referred to herein as a “bookmark” operation, and then to store and access the state for subsequent use. The state can be automatically captured in response to the bookmark click. The state is captured relative to a point of reference, such as time, user, one or more keywords, and reference to a document, for example. Thus, all state elements such as media (e.g., audio, video, images, text, documents, etc.), document views, point of presentation in the document (e.g., cell in spreadsheet, slide in slide deck, etc.), document types, screen capture of currently presented video, etc.), as well as location information, participants (including presenter), communications, sidebar communications between a subset of the meeting participants, current agenda items, content source information (e.g., laptop of specific user, mobile phone, etc.), and so on, can be captured. The quantity and type of information that can be captured as the meeting state is not limited.

The bookmark assigned to the state at a particular reference (e.g., time) can be selected to rehydrate all the state elements captured and associated with that bookmark (e.g., getting back to the point in the meeting to perceive a relevant portion of a document, part of the meeting video, or other recorded feed), as well as all other allowed state elements. A bookmark inserted within the content can then link back to other relevant data. Users can initiate the bookmark operation from different types of devices including digital whiteboards, audio/video conferencing systems, laptops, desktop computers, and mobile devices, for example.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented meeting context system in accordance with the disclosed architecture.

FIG. 2 illustrates a diagram of meeting state input from multiple meeting sources and triggers that when selected capture the meeting state at points of reference.

FIG. 3 illustrates an exemplary representation of a bookmark expression and the associated entities.

FIG. 4 illustrates a computer-implemented meeting context method in accordance with the disclosed architecture.

FIG. 5 illustrates further aspects of the method of FIG. 4.

FIG. 6 illustrates further aspects of the method of FIG. 4.

FIG. 7 illustrates a block diagram of a computing system that executes meeting context capture in accordance with the disclosed architecture.

### DETAILED DESCRIPTION

The disclosed architecture enables a user to bookmark a specific point in time within a meeting using software that facilitates communication and collaboration, tracking meeting activities, attendees, and documents. At this point of bookmarking, the meeting system automatically captures the context of the meeting (that is being tracked). Users can retrieve the bookmarked context (e.g., slide) from the meeting system by selecting the associated bookmark, at any subsequent time or even during the meeting. However, note that time is not a necessary aspect. For example, retrieval can be achieved by selecting the desired bookmark, or by referencing an element and then finding which bookmarks include the element (e.g., a slide 12, an item of conversation, a comment that was added during the meeting, etc.).

When a user triggers the capture of state (the state comprises the state elements of a given point in time of the meeting) elements the system automatically collects and records the various elements of the state. The elements of meeting state captured can include, but are not limited to: current document shown in the meeting (e.g., website, video, spreadsheet, etc.), current part of a document in view (e.g., slide in a presentation deck, cell in a spreadsheet, etc.), presenter, timestamp, associated meeting (e.g., metadata such as subject and attendees), screen capture, image, audio and video capture (from audio or video conferencing), current agenda item, sidebar conversations, location, addressing, participant communications mechanism (e.g., computer, laptop, mobile phone, etc.), and other sources of content.

This state information is available at any time, including after the meeting has ended, and can be shared with others. In a more restrictive environment, the state information can be made available only at specific times, such as only after the meeting, only during the meeting, only for one week immediately following the meeting, and so on, and in another implementation, then only to specific users. The state can be rehydrated to bring back the elements at specific point of time from the meeting, the rehydration process includes opening a document, navigating to a specific position in the document, replaying and displaying images, screens, audio and/or video captured, and displaying meeting metadata, for example. The state captured can be used for various purposes, including, but not limitedto, expressing approval, bookmarking, commenting (with annotation), and continuing or resuming the meeting at a later time, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

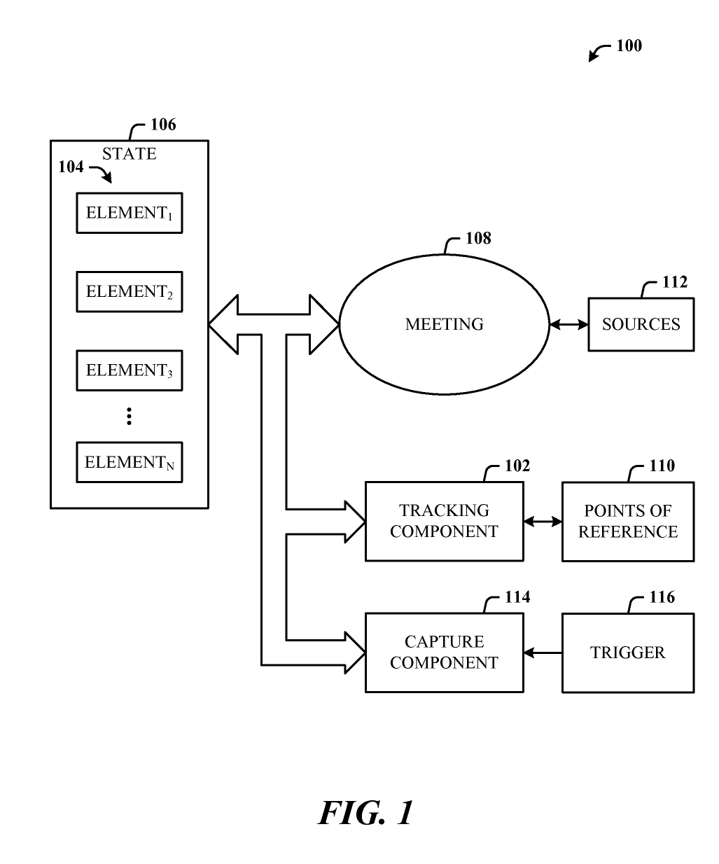

FIG. 1 illustrates a computer-implemented meeting context system 100 in accordance with the disclosed architecture. The system 100 includes a tracking component 102 that tracks elements 104 of state 106 of a meeting 108 of multiple users relative to points of reference 110.

The elements 104 of state 106 include many different aspects of the meeting 108 and participants who interact with the meeting 108 via sources such as computers, and mobile devices. For example, the state can include, but is not limited to, meeting content as elements in the form of media (e.g., audio, video, images, text, documents, etc.) document views, point of presentation in the document (e.g., cell in spreadsheet, slide in slide deck, etc.), document types, screen capture of currently presented video, etc.), as well as location information, participants (including presenter), participant connection information (e.g., location, time, duration, input, address, etc.), communications (e.g., email, text, instant messages, etc.), sidebar communications (e.g., between a subset of the meeting participants offline from the main meeting, or with other users not attending the meeting, etc.), current agenda items, content source information (e.g., laptop of specific user, mobile phone, etc.), and so on.

The state 106 includes content from sources 112 utilized as part of the meeting 108. The system 100 also includes a capture component 114 that captures state at a point of reference in response to a user-initiated and identifiable trigger 116. Alternatively, or in combination therewith, the trigger can be initiated automatically based on audio information such as applause, and/or duration of content presentation (e.g., slide presented for more than ten minutes), or a specified action by the system (e.g., opening a document, sharing a screen, etc.), for example. The trigger can be uniquely identified in software according to the user that initiated it, login information, timestamp, network address, or other commonly known techniques for making data uniquely identifiable. The captured state and corresponding point of reference are stored in association with the identifiable trigger 116.

The point of reference can be time-based such as a timestamp associated with the captured state. Alternatively, the point of reference can be based on the contributor such as the meeting presenter. Thus, when captured and stored, the captured state can be identified by the presenter as a point of reference. The meeting 108 can be established and conducted using software that facilitates communications and collaboration (e.g., audio/video conferencing applications, email applications, etc.). The identifiable trigger 116 is received from one or more of the sources 112, which include devices that comprise a computer, a whiteboard, and/or a mobile device.

Other meeting equipment can include a centralized audio/video system that facilitates audio communications with participants both local and remote, and/or video communications via video (camera) systems of computers and the centralized audio/video system. Other actions can be tracked by the system such as a camera or personally identifiable sensor (e.g., RFID (radio frequency identification) chip of user badge) that detects when a user enter/leaves a room, or a system that detects when people raise a hand to ask a question, for example. In an alternative embodiment, the system can trigger on sensors such as biometrics or trigger when the user types/inks notes in an application for an input source (e.g. audio/video).

The captured state can be shared with another user (or meeting participant) or group of users (meeting participants) by sharing the identifiable trigger. The user-initiated and identifiable trigger can be instantiated as a single-click user interface (UI) control. The identifiable trigger can be represented to a user as a bookmark type of UI control. The identifiable trigger is processed to obtain the associated captured state. The meeting state elements captured at the point of reference are at least one of current document shown in the meeting, current part of the document shown in the meeting, presenter, timestamp, meeting metadata, audio media, video media, image media, or agenda item.

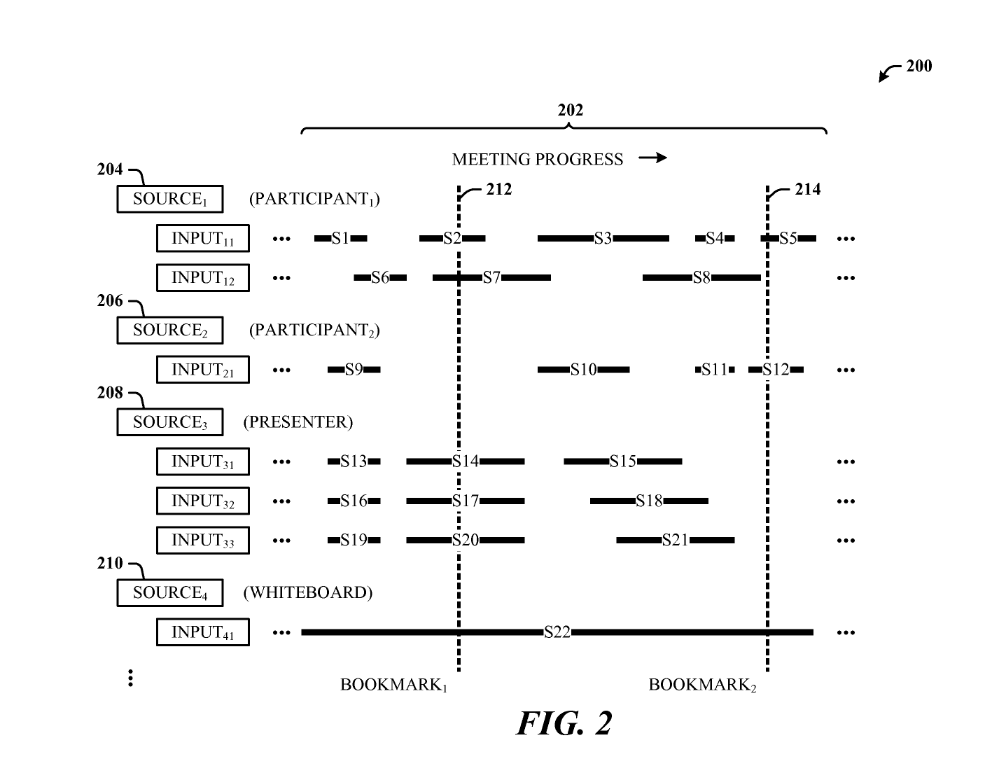

FIG. 2 illustrates a diagram 200 of meeting state input from multiple meeting sources and triggers that when selected capture the meeting state at points of reference. Here, a window (or duration) 202 of meeting state is shown in which two triggers are initiated to capture meeting state. Three sources are illustrated as providing input to a meeting: a first source 204 of a first participant (PARTICIPANT₁) that provides first and second types of input, a second source 206 of a second participant (PARTICIPANT₂) that provides a third type of input, a third source 208 of a presenter (PRESENTER) that provides fourth, fifth and sixth types of input, and a fourth source 210 (WHITEBOARD) (which is a whiteboard or other piece of conferencing equipment, for example) that provides a seventh type of input. Other sources and inputs can be utilized and captured as well.

As illustrated in this window 202, the first input of the first source 204 includes five elements of state (S1-S5). The second input of the first source 204 includes three elements of state (S6-S8). The first input can be audio input such as via a microphone of a laptop computer that is communicated to the meeting as audio signals. The second input can be textual input that the first participant is inputting via an email program or via a word processing program, and visually perceived by the other meeting participants, for example.

The third input of the second source 206 (PARTICIPANT₂) includes four elements of state (S9-S12), which can be email communications or audio input, or video input, for example. The fourth input of the third source 208 includes three elements of state (S13-S15), which can be content and other digital information related to a presentation program that displays slides for viewing by the presenter and meeting participants. The fifth input includes three elements of state (S16-S18), which can be audio information that the presenter is voicing at this time. The sixth input includes three elements of state (S19-S21), which can be sidebar content being communicated textually between the presenter and a meeting participant or user outside the meeting, for example. The seventh input includes one state element (S22), which is from the whiteboard in the physical meeting room on which information is written/drawn for viewing and ultimately, captured electronically.

Note that the duration of each of the elements can vary. For example, element S14 can be the duration of which a slide is presented. The first trigger 212 then initiates capture of the slide at that moment in time. Similarly, the element S17 can be the audio content voiced by the presenter as the slide is being presented. A bookmark can be a range of time, not just a point in time. For example, if a user bookmarks the slide, the range of time the slide is in view can also be associated with the bookmark for retrieval.

A first trigger 212 is initiated at a point of reference in the window 202, at which time, state elements are captured and stored. Here, activation (or selection) of the first trigger 212 captures elements S2, S7, S14, S17, S20 and S22. The information associated with each of these elements is then processed and stored in association with the identification of the first trigger 212, as a first bookmark (BOOKMARK₁). Similarly, a second trigger 214 is initiated at a point of reference in the window 202, at which time, state elements are captured and stored. Here, activation (or selection) of the second trigger 214 captures state elements S5, S12, and S22. The information associated with each of these elements is then processed and stored in association with the identification of the second trigger 214, as a second bookmark (BOOKMARK₂).

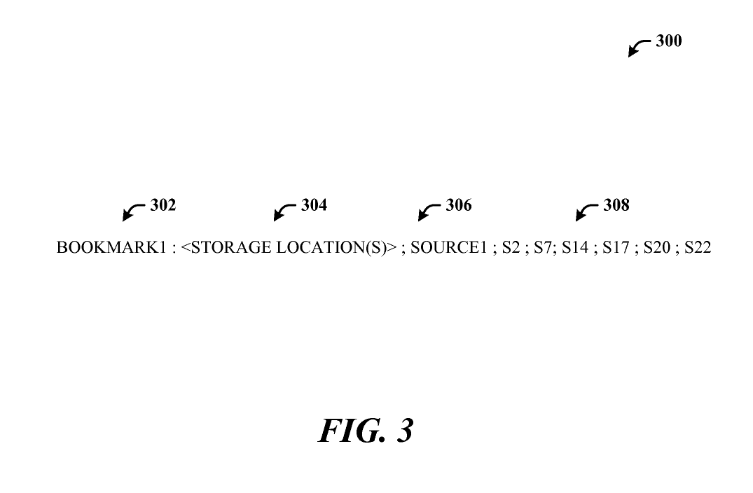

FIG. 3 illustrates an exemplary representation of a bookmark expression 300 and the associated entities. This is just but one way in which the association of the state elements to a bookmark can be made. Continuing with the embodiment of FIG. 2, the first bookmark can be stored as an expression that identifies the bookmark name or identifier 302, storage location(s) 304 of the bookmark, the source 306 (e.g., user or user machine) from which the trigger was initiated, and elements 308 captured and associated with the bookmark. Accordingly, when the user interacts with a single-click user interface control, the bookmark 300 is automatically created to store the elements and other information, as well as to re-access the meeting context by thereafter selecting the bookmark to rehydrate all the content and elements associated with the bookmark. The storage location can be a single local location, a remote (network location) and/or distributed across multiple locations.

Put another way, a meeting context system is provided that includes a tracking component that tracks meeting elements of a meeting relative to time. The meeting elements include input from sources utilized as part of a meeting lifecycle (pre-meeting, during the meeting, after the meeting). A capture component captures meeting elements at a given point in time in response to a user-initiated trigger of a single-click user interface control (e.g., a control labeled Bookmark). The captured meeting elements and time of the capture are stored in association with the bookmark.

The capture component rehydrates the meeting elements captured in association with the time based on processing of the bookmark. The rehydration is the fully synchronized meeting context as it originally occurred. The meeting elements include meeting activities, participant information, and content. The captured meeting elements can be restricted to personal access or open to public or corporate access (e.g., team, organization, company, everyone, etc.). In other words, a participant can capture the state at any given point in time strictly for personal use and access. Whereas, a meeting assistant (e.g., human or automated system) can initiate multiple bookmarks throughout the meeting lifecycle in order to provide a more complete storybook or record of all state and associated meeting metadata. This can also be utilized for auditing at a later time, for example.

The bookmark (identifiable trigger) can be customized or annotated for specific identifiable purposes. For example, the bookmark can be annotated to convey extra meaning/categorization such as Follow-Up, Good Job, Needs Improvement, Boring, Private, Shared, Public, and so on,

In one embodiment, most if not all user activities and the meeting are captured in the cloud (Internet-based resources and services) such that all communications of media is also captured and stored in the cloud. However, this is not a requirement, since the bookmark and captured elements can be stored locally for the desired purpose(s). This can also become part of content. For example, if a user tags Slide 6 during a meeting, that data can be stored within that slide deck so at any point, regardless of from where the file is accessed, it could point back to other data, that is, comments in this document roam with the document, but can point to other sources.

It can be the design that the bookmark time is automatically adjusted a predetermined time before the actually trigger for the bookmark. Thus, the user will automatically receive content before the actual trigger point (e.g., five seconds).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

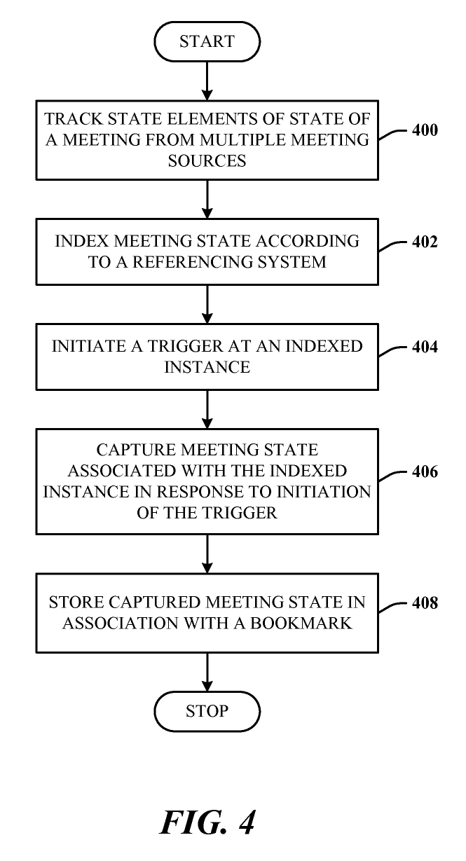

FIG. 4 illustrates a computer-implemented meeting context method in accordance with the disclosed architecture. At 400, state elements of state of a meeting are tracked from multiple meeting sources. At 402, the meeting state is indexed according to a referencing system. At 404, a trigger is initiated at an indexed instance. At 406, meeting state associated with the indexed instance is captured in response to initiation of the trigger. At 408, the captured meeting state is stored in association with a bookmark.

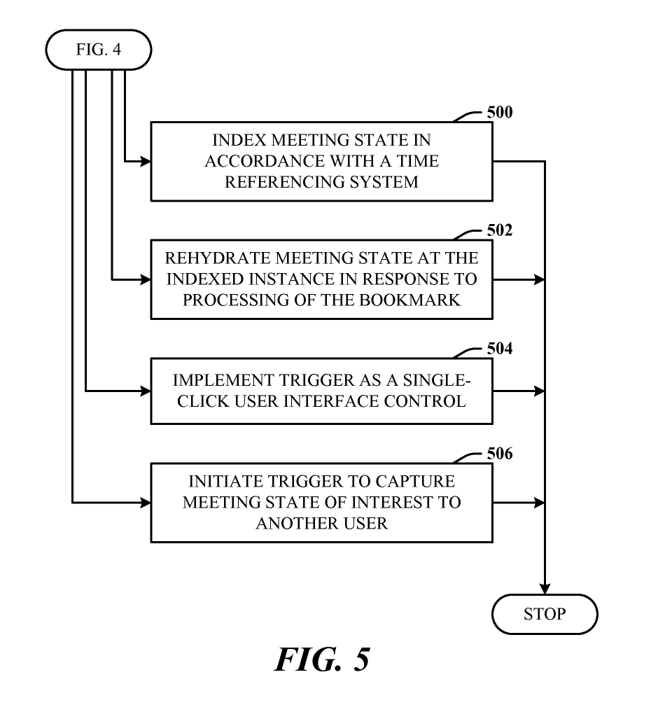

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, the meeting state is indexed in accordance with a time referencing system. At 502, the meeting state is rehydrated at the indexed instance in response to processing of the bookmark. At 504, the trigger is implemented as a single-click user interface control. At 506, the trigger is initiated to capture meeting state of interest to another user.

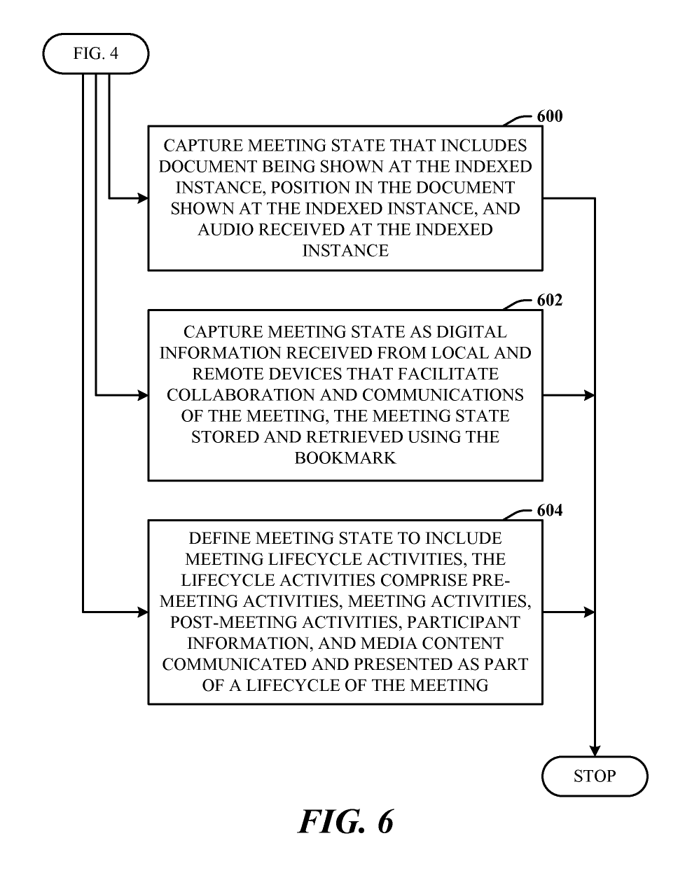

FIG. 6 illustrates further aspects of the method of FIG. 4. Note that the flow indicates that each block can represent a step that can be included, separately or in combination with other blocks, as additional aspects of the method represented by the flow chart of FIG. 4. At 600, meeting state that includes document being shown at the indexed instance, position in the document shown at the indexed instance, and audio received at the indexed instance, is captured. At 602, the meeting state is captured as digital information received from local and remote devices that facilitate collaboration and communications of the meeting, the meeting state stored and retrieved using the bookmark. At 604, the meeting state is defined to include meeting lifecycle activities, the lifecycle activities comprise pre-meeting activities, meeting activities, post-meeting activities, participant information, and media content communicated and presented as part of a lifecycle of the meeting.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

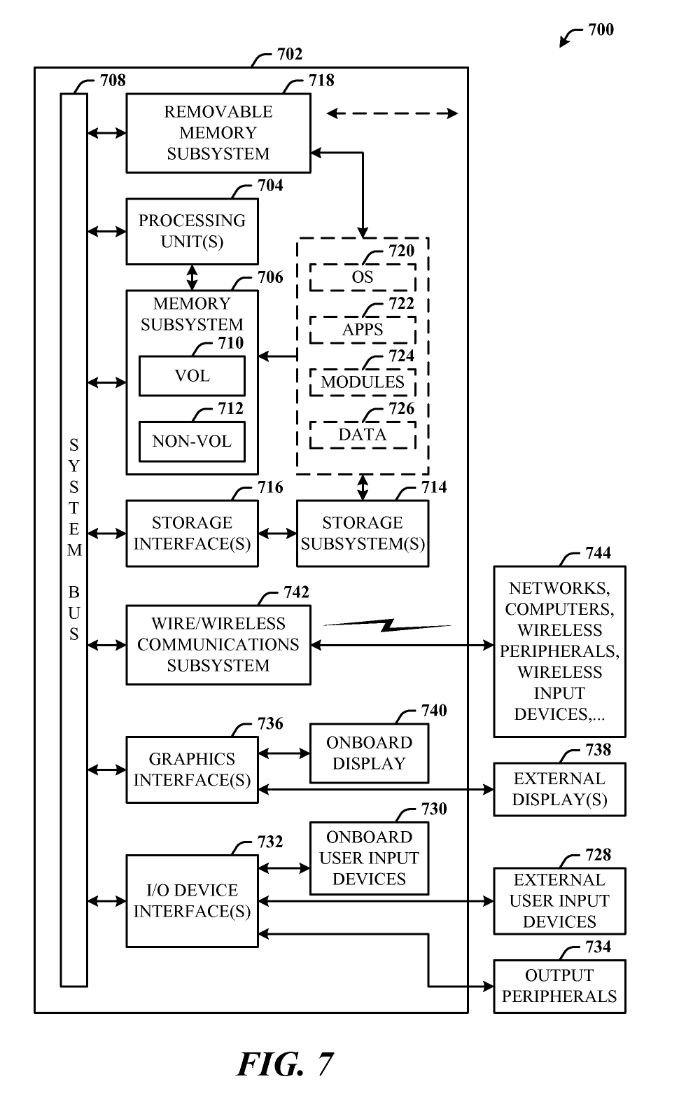

Referring now to FIG. 7, there is illustrated a block diagram of a computing system 700 that executes meeting context capture in accordance with the disclosed architecture. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The one or more application programs 722, other program modules 724, and program data 726 can include the entities and components of the system 100 of FIG. 1, the entities of the diagram 200 of FIG. 2, the bookmark 300 of FIG. 3, and the methods represented by the flowcharts of FIGS. 4-6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented meeting context system, comprising:
a tracking component that tracks elements of state of a meeting of multiple users relative to points of reference, the state includes content from sources utilized as part of the meeting;
a capture component that captures state at a point of reference in response to an initiated and identifiable trigger, the captured state and corresponding point of reference stored in association with the identifiable trigger; and
a processor that executes computer-executable instructions associated with at least the tracking component and the capture component.

2. The system of claim 1, wherein the point of reference is a timestamp associated with the captured state.

3. The system of claim 1, wherein the meeting is established and conducted using software that facilitates communications and collaboration.

4. The system of claim 1, wherein the identifiable trigger is received from devices that include at least one of a computer, a whiteboard, or a mobile device.

5. The system of claim 1, wherein the captured state is shared with another user or group of users by sharing the identifiable trigger.

6. The system of claim 1, wherein the identifiable trigger is searched to obtain the associated captured state.

7. The system of claim 1, wherein the initiated and identifiable trigger is instantiated as a single-click user interface control.

8. The system of claim 1, wherein the meeting state elements captured at the point of reference are at least one of current document shown in the meeting, current part of the document shown in the meeting, presenter, timestamp, meeting metadata, audio media, video media, image media, or agenda item.

9. A computer-implemented meeting context system, comprising:
a tracking component that tracks meeting elements of a meeting relative to time, the meeting elements include input from sources utilized as part of a meeting lifecycle;
a capture component that captures meeting elements at a given point in time in response to an initiated trigger of a single-click user interface control, the captured meeting elements and time of the capture stored in association with a bookmark; and
a processor that executes computer-executable instructions associated with at least the tracking component and the capture component.

10. The system of claim 9, wherein the capture component rehydrates the meeting elements captured in association with the time based on processing of the bookmark.

11. The system of claim 9, wherein the meeting elements include meeting activities, participant information, and content.

12. The system of claim 9, wherein the captured meeting elements are restricted to personal access or open to public access.

13. A computer-implemented meeting context method, comprising acts of:
tracking state elements of state of a meeting from multiple meeting sources;
indexing the meeting state according to a referencing system;
initiating a trigger at an indexed instance;
capturing meeting state associated with the indexed instance in response to initiation of the trigger;
storing the captured meeting state in association with a bookmark; and
utilizing a processor that executes instructions stored in memory to perform at least the acts of tracking, indexing, capturing, and storing.

14. The method of claim 13, further comprising indexing the meeting state in accordance with a time referencing system.

15. The method of claim 13, further comprising rehydrating the meeting state at the indexed instance in response to processing of the bookmark.

16. The method of claim 13, further comprising implementing the trigger as a single-click user interface control.

17. The method of claim 13, further comprising initiating the trigger to capture meeting state of interest to another user.

18. The method of claim 13, further comprising capturing meeting state that includes document being shown at the indexed instance, position in the document shown at the indexed instance, and audio received at the indexed instance.

19. The method of claim 13, further comprising capturing the meeting state as digital information received from local and remote devices that facilitate collaboration and communications of the meeting, the meeting state stored and retrieved using the bookmark.

20. The method of claim 13, further comprising defining the meeting state to include meeting lifecycle activities, the lifecycle activities comprise pre-meeting activities, meeting activities, post-meeting activities, participant information, and media content communicated and presented as part of a lifecycle of the meeting.
